(19) United States
(12) Patent Application Publication
(10) Pub. No.: US 2008/0185435 A1
(43) Pub. Date: Aug. 7, 2008

(54) Card reader with manipulation detection

(76) Inventor: Juergen Hopt, Rottweil (DE)

Correspondence Address: WALTER A. HACKLER, Ph.D.;PATENT LAW OFFICE, 2372 S.E. BRISTOL STREET, SUITE B, NEWPORT BEACH, CA, 92660-0755, US

(21) Appl. No.: 12/009,718

(22) Filed: Jan. 22, 2008

(30) Foreign Application Priority Data
Feb. 2, 2007 (DE) 20 2007 001 626.3

(51) Int. Cl. G06K 7/06

(52) U.S. Cl. 235/441

(57) ABSTRACT

In accordance with the invention, in a card reader for data exchange with a card that stores data, exposed electrical contacts of the card reader, via which the exchanged data is transmitted in an uncoded fashion, are covered by a cap, and a switch covered by the cap is triggered by removing the cap.

This application claims Paris Convention priority of DE 20 2007 001 626.3 filed 6 Feb. 2007, the complete disclosure of which is hereby incorporated by reference.

The present invention relates to a card reader for data exchange with a card that stores data.

### BACKGROUND OF THE INVENTION

With conventional card readers of this type, it is possible to manipulate data exchange with a card by contacting the exposed electrical contacts of the card reader via which the exchanged data is transferred in an uncoded fashion.

It is the object of the present invention to detect and, if necessary prevent, such manipulations on a card reader of the above-mentioned type.

### SUMMARY OF THE INVENTION

This object is achieved in accordance with the invention in that the exposed electrical contacts of the card reader, via which the exchanged data is transmitted in an uncoded fashion, are covered by a cap, and a switch that is covered by the cap is triggered when the cap is removed.

The switch is advantageously formed by a reed switch that is fixed to the housing and is covered by the cap when the cap is attached. On its inner side, the cap has a magnet that cooperates with the reed switch when the cap is attached. The reed switch has the substantial advantage that it is triggered not only when the cap is removed but also through mere displacement of the cap.

Further advantages of the invention can be extracted from the description, the claims, and the drawing. The features mentioned above and below may be used individually or collectively in arbitrary combination. The embodiment shown and described is not to be understood as an exhaustive enumeration but has exemplary character for describing the invention.

### BRIEF DESCRIPTION OF THE DRAWING

FIG. 1 shows a sectional view of the inventive card reader in accordance with I-I of FIG. 2;

FIG. 2 shows a top view of the card reader of FIG. 1; and

FIG. 3 shows a sectional view of the card reader in accordance with III-III of FIG. 1.

### DESCRIPTION OF THE PREFERRED EMBODIMENT

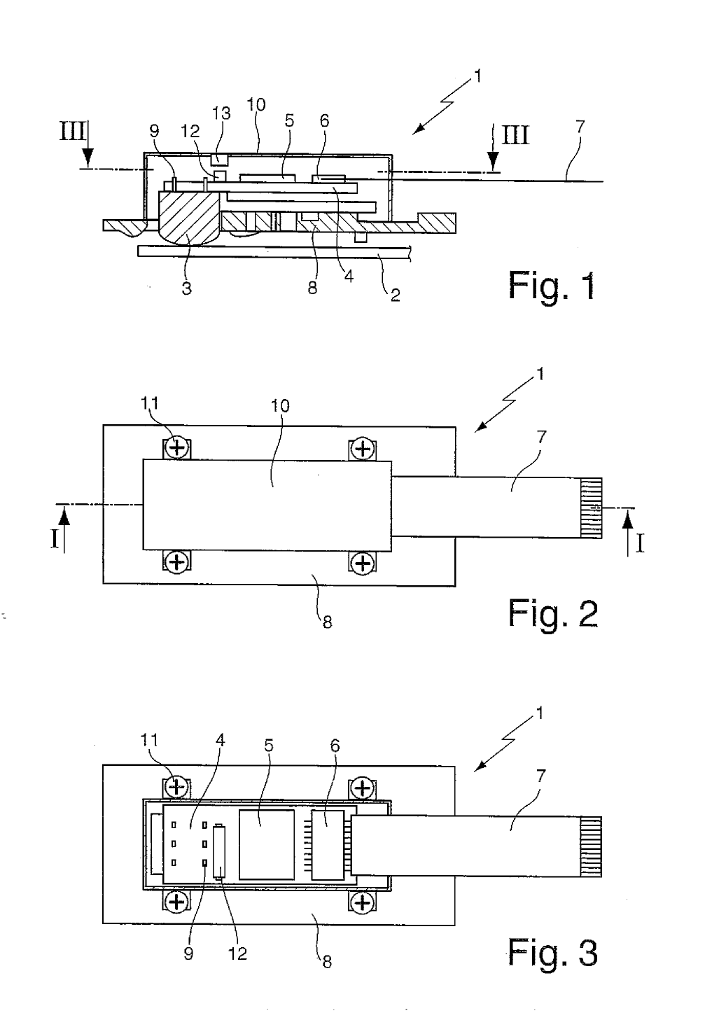

The chip card reader 1 shown in FIGS. 1 through 3 is used to read the data of a magnetic card 2 that comprises a magnetic strip for storing data and has been inserted into the card reader 1.

The chip card reader 1 has a magnetic head (read head) 3 that is disposed on the front side of a printed circuit board 4, and the read side of which extends to the close vicinity of the card path in order to read the data of a passing magnetic card 2. The data read in this fashion is encoded by means of a microprocessor (encoding unit) 5 disposed on the rear side of the printed circuit board 4, and the encoded data is extracted via a plug (e.g. molex plug) 6 and a flexible printed board 7 for further processing. The printed circuit board 4 is mounted to the reader housing 8, wherein the magnetic head 3 extends through an opening of the reader housing 8 to the close vicinity of the card path.

The read data is transmitted in an uncoded fashion between the head 3 and the microprocessor 5 and could be tapped there at exposed electrical contacts 9, such as e.g. at the contact legs of the magnetic head 3 soldered to the rear side of the printed circuit board 4, or at rear-sided conductor paths of the printed circuit board 4 for manipulation. In order to detect such manipulation, all exposed electrical contacts 9, via which the read data is transmitted in an uncoded fashion, are covered or surrounded by a cap 10 having a thickness of approximately 0.5 mm. To be more precise, the entire rear side of the printed circuit board 4 including all structural components provided thereon, is covered by the cap 10. The cap 10 is mounted to the card reader housing carrier 8 by four screws 11. The cap 10 is additionally secured by a reed switch 12 that is disposed on the rear side of the printed circuit board 4 and cooperates with a magnet 13 disposed on the inner side on the cap 10. The reed switch 12 is part of a monitoring means that is integrated in the microprocessor 5, or is part of an external control unit.

When the cap 10 is mounted onto the card reader housing carrier 8 and screwed on, the reed switch 12 is closed by the magnet 13. When the cap 10 is unscrewed and lifted, the reed switch 12 is opened. The reed switch 12 is opened by a movement of the magnet 13 towards the reed switch 12 of approximately 0.5 to 1 mm, and is detected by the microprocessor 5 or by the external control unit, which will then block any read process of the magnetic head 3 or render the microprocessor 5 inoperative. Unnoticed manipulation of the electrical contacts 9 is thus not possible, and a “manipulation-proof” card reader 1 is provided.

We claim:

1. Card reader apparatus for data exchange with a card that stores data, the apparatus comprising:
exposed card reader electrical contacts for transmitting the exchanged data in an uncoded fashion;
a cap covering the controls; and
a switch covered by the cap, the switch being triggered by removing the cap.

2. Card reader according to claim 1, wherein the switch is formed by a reed switch that is fixed to the housing and is covered by the cap when the cap is attached, and the cap has a magnet on its inner side that cooperates with the reed switch when the cap is attached.

3. Card reader according to claim 1, wherein the switch is formed by a reed switch that is disposed on the inside of the cap and cooperates with a magnet that is fixed to the housing and is covered by the cap when the cap is attached.

4. Card reader according to claim 1, wherein the cap is screw mounted to the card reader housing.

5. Card reader according to claim 1, wherein the exposed electrical contacts are provided between a read head of the card reader and an encoding unit that encodes the read data.

6. Card reader according to claim 5, wherein the exposed electrical contacts are provided on a printed circuit board on which the read head, the encoding unit and the reed switch are disposed, and the printed circuit board is covered by the attached cap.

7. Card reader according to claim 6, wherein a plug that is connected to the encoding unit is provided on the printed circuit board, and a cable extending out of the attached cap is inserted into the plug.

8. Card reader according to claim 1, wherein the switch is connected to an internal monitoring means that is integrated, in particular, in the encoding unit, or to an external control unit.

9. Card reader according to claim 2, wherein the cap is mounted, in particular screwed, to the card reader housing, wherein the exposed electrical contacts are provided between a read head of the card reader and an encoding unit that encodes the read data, wherein the exposed electrical contacts are provided on a printed circuit board on which the read head, the encoding unit and the reed switch are disposed, and the printed circuit board is covered by the attached cap, wherein a plug that is connected to the encoding unit is provided on the printed circuit board, and a cable extending out of the attached cap is inserted into the plug, and wherein the switch is connected to an internal monitoring means that is integrated, in particular, in the encoding unit, or to an external control unit.

10. Card reader according to claim 3, wherein the cap is mounted, in particular screwed, to the card reader housing, wherein the exposed electrical contacts are provided between a read head of the card reader and an encoding unit that encodes the read data, wherein the exposed electrical contacts are provided on a printed circuit board on which the read head, the encoding unit and the reed switch are disposed, and the printed circuit board is covered by the attached cap, wherein a plug that is connected to the encoding unit is provided on the printed circuit board, and a cable extending out of the attached cap is inserted into the plug, and wherein the switch is connected to an internal monitoring means that is integrated, in particular, in the encoding unit, or to an external control unit.
